(19) United States
(12) Patent Application Publication
(10) Pub. No.: US 2005/0190700 A1
(43) Pub. Date: Sep. 1, 2005

(54) Wireless communication arrangements with packet transmissions

(75) Inventor: Diego Melpignano, Monza (IT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/513,274

(22) PCT Filed: Apr. 15, 2003
(86) PCT No.: PCT/IB03/01525

§ 371 Date: Nov. 2, 2004

(30) Foreign Application Priority Data
May 7, 2002 (EP) 03276826.3

(51) Int. Cl. H04L 1/00

(52) U.S. Cl. 370/244

(57) ABSTRACT

A method is disclosed for packet-based wireless transmission between a first unit and a second unit, the method including a said unit: a) generating packets suitable for transmission between said units; b) transmitting said packets in succession during active periods on a wireless channel, successive said active periods being spaced apart by a number of timeslots of predetermined duration; c) implementing a low power mode in timeslots between said active periods; and d) setting the duration of operation in at least one of said active period and said low power mode in dependence on the status of said channel.

The present invention relates to wireless communication arrangements and to methods of operating the same, in particular to a wireless communications arrangement and to a method of operating the same in which packet transmissions are sent from one wireless unit to another wireless unit. The present invention also relates to communications units and to software products used in such arrangements.

Wireless communications systems based on radio units and connections used to group them at least temporarily into a shared resource network are known. One current implementation of this general type is in the form of a short-range, frequency-hopping network and is known in the art as Bluetooth communications. This arrangement is controlled by the Bluetooth standard and a full specification for conformity in Bluetooth communications can be found through the Bluetooth Special Interests Group (SIG), whose web site can be found at “www.bluetooth.com” along with the current Bluetooth standard and related information. It is acknowledged throughout this specification that Bluetooth is a trademark of the Bluetooth SIG.

A useful discussion of Bluetooth communications can be found in text book form in “Bluetooth, Connect Without Wires” by Jennifer Bray and Charles F. Sturman, published by Prentice Hall PTR under ISBN 0-13-089840-6.

Further prior art can be found in, for example, U.S. published applications 2001/0010689A1 and 2001/0006512A1, in which some aspects of the current state of the art in this field are also discussed.

The reader is referred to the above mentioned sources for general Bluetooth background information and also, for example, for clarification of terms of art used herein and not specifically defined.

In corporate networks, the provision of voice connectivity to mobile users usually needs a separate infrastructure with dedicated access points and terminals, like in the case of the DECT system. With the large deployment of Bluetooth (BT) transceivers in a variety of terminals, it will be possible to re-use BT enabled mobile phones or PDAs also for corporate voice services. Furthermore the same Bluetooth access points can be used for both voice and data services.

Each access point in a Bluetooth network forms a Bluetooth piconet with one or more mobile terminals, such as for example mobile telecommunications handsets. An emerging application for Bluetooth is the delivery of Voice over Internet Protocol (VoIP), as well as other types of IP traffic such as data or audio/visual traffic, which are being deployed over the internet as well as in corporate networks/intranets. The main advantage of VoIP is its use by voice trffic of an existing network infrastructure typically used for data.

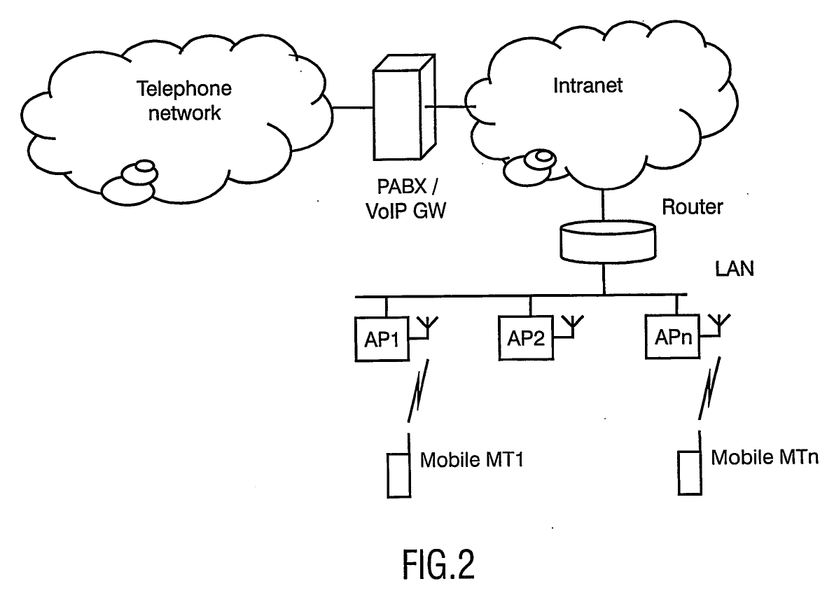

In the Bluetooth standard, voice communication uses a dedicated channel named “SCO” (Synchronous Connection Oriented) that can be established on top of any link between two Bluetooth devices, such an arrangement being shown with particular reference to FIG. 2. According to this scheme, two baseband slots are reserved out of each six for full duplex communication across a 64 kbps voice channel. This voice link can be established, for example, between a mobile terminal MT and an access point AP. Since many handsets (or other terminals) may be attached to the same access point, it can be seen that it is important to maximize efficiency in the usage of the limited bandwidth available (1 Mbps gross aggregate capacity per piconet) and low power reserves of some mobile terminals MT. A mobile terminal can only use a low-power mode during the four slots available between two consecutive SCO packet pairs, provided no data traffic has to be sent. Furthermore, the two baseband slots are used even during silence in the voice conversation since voice is coded with simple μ-law or bylaw PCM. While being simple to manage, it can be seen that the current SCO arrangement may prove wasteful of bandwidth and/or power.

It is an object of the present invention to provide improved wireless communication arrangements and improved methods of operating the same. It is a further object of the present invention to provide improvements to wireless communications arrangements and to methods of operating the same in which packet transmissions are sent from one wireless unit to another wireless unit. It is a particular object of the present invention to provide power savings in such arrangements and methods with respect to the state-of-the-art. It is also an object of the present invention to provide improved communications units and software products used in such arrangements and methods.

Accordingly, the present invention provides a method for packet-based wireless transmission between a first unit and a second unit, the method including a said unit:
a) generating packets suitable for transmission between said units;
b) transmitting said packets in succession during active periods on a wireless channel, successive said active periods being spaced apart by a number of timeslots of predetermined duration;
c) implementing a low power mode in timeslots between said active periods; and
d) setting the duration of operation in at least one of said active period and said low power mode in dependence on the status of said channel.

The method may include determining said status at least in part according to an estimation of a channel bit error rate (BER), any other equivalent estimation of error rate or a characteristic of transmissions related to or derived from the BER.

The method may include, for example, deriving said bit error rate from a number of timeout events, from a rate of packet retransmission or from a received signal strength (RSSI) measurement.

The method may include applying a timeout to the transmission of a said packet and setting at least one of said active period and said low power mode at least in part in dependence on the duration of said timeout.

The method may include setting the duration of said timeout at least in part in dependence on the length of time taken to transmit a said packet.

The method may include setting at least one of said active period and said low power mode at least in part in dependence on the rate of generation of said packets.

The method may include determining said status from an estimate of wireless channel conditions between said units.

The method may include configuring a said unit as a master unit and the other said unit as a slave unit, and negotiating for an existing baseband connection therebetween the implementation of at least said active period.

The method may include periodically checking the status of said channel conditions and renegotiating the duration of said active period and a flush timeout under predetermined circumstances ensuing from a said status check. The method may include making said master unit responsible for polling said slave unit during agreed said active periods. The method may include configuring said slave unit to listen for an attempt at polling during a predetermined number of said timeslots during a said active period and, in the event of receiving a said packet bearing its address, to continue listening for a predetermined listening timeout. The method may include setting the amount of time said slave unit spends active on said channel on dependence on said listening timeout and varying said listening timeout in dependence on channel conditions.

The method may include allowing packet transmissions to extend beyond the duration of a said active period under predetermined circumstances.

The method may include setting an allowable number of packet retransmissions and increasing said number in response to an increase in channel bit error rate above a level at which a said number was set.

The method may include varying a flushing timeout associated with a logical channel used to carry said packets, said variation being dependent on the number of timeslots in said active period.

The method may include generating said packets by:
a) converting a real-time bit stream into one or more payloads of predetermined maximum length and applying one or more predefined headers to the or each said payload so as to generate said packets in accordance with a predefined communications protocol;
b) applying a predefined header compression technique to the or each said encapsulated packet and encapsulating the or each said packet within a frame of an encapsulation protocol adapted for transporting the or each said packet across a wireless connection between said units. Said protocol preferably comprises the Bluetooth protocol.

The method may include generating the or each said payload from a said real time bit stream comprising Internet Protocol (IP) traffic, such as Voice-over-Internet-Protocol (VoIP), audio or visual streams.

The method may include operating said units in accordance with the Bluetooth protocol and said low power mode preferably comprising a Bluetooth SNIFF mode.

The present invention also provides a software product for executing packet-based wireless transmission between a first unit and a second unit, the product including code for:
a) generating packets suitable for transmission between said units;
b) transmitting said packets in succession during active periods on a wireless channel, successive said active periods being spaced apart by a number of timeslots of predetermined duration;
c) implementing a low power mode in timeslots between said active periods; and
d) setting the duration of operation in at least one of said active period and said low power mode in dependence on the status of said channel.

The present invention also provides a packet based wireless communications arrangement comprising a first unit adapted to communicate information to a second unit substantially in real-time, said first unit being adapted to:
a) generate packets suitable for transmission between said units;
b) transmit said packets in succession during active periods on a wireless channel, successive said active periods being spaced apart by a number of timeslots of predetermined duration;
c) implement a low power mode in timeslots between said active periods; and
d) set the duration of operation in at least one of said active period and said low power mode in dependence on the status of said channel.

Said units may be operable in accordance with the Bluetooth protocol and said low power mode preferably comprising a Bluetooth SNIFF mode.

The present invention also provides a wireless communications unit adapted to operate in accordance with the method of the invention and preferably configured at least temporarily as at least one of a master unit and a slave unit of a radio communications network, for example a Bluetooth communications network.

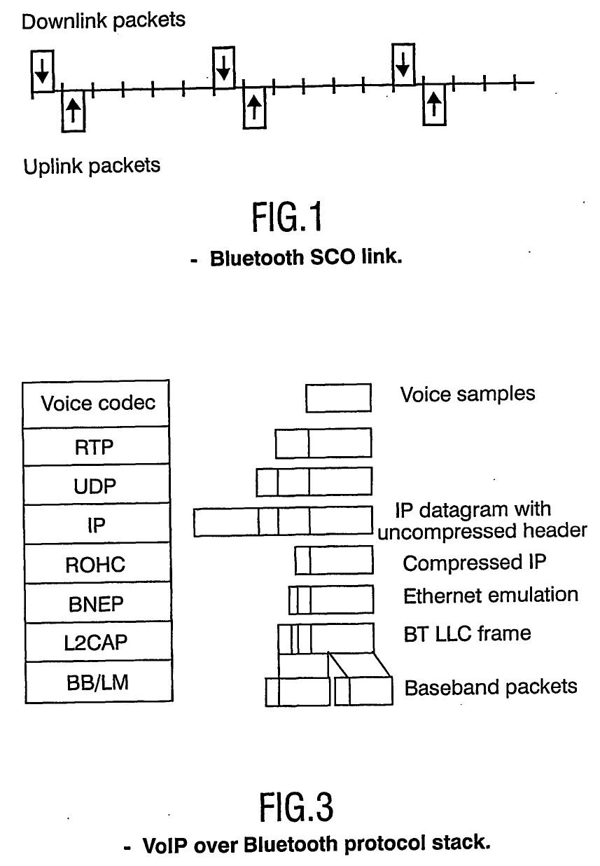

FIG. 1 is a representation of a Bluetooth SCO link;

FIG. 2 is a schematic diagram of a communications system in which are implemented aspects of the present invention;

FIG. 3 represents the protocol stack in an arrangement according to an embodiment of the present invention;

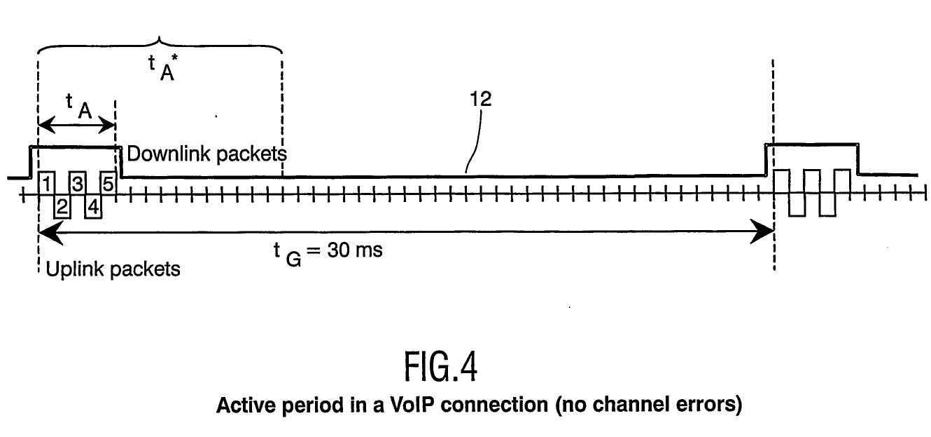

FIG. 4 is a representation of an active period in a Voice over Internet Protocol (VoIP) connection in the system of FIG. 2;

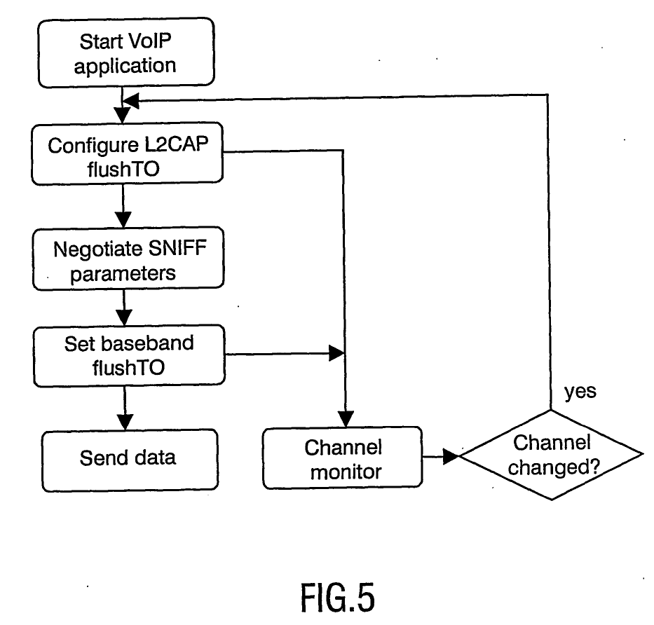

FIG. 5 is a high level flow chart of wireless transmission according to an embodiment of the present invention;

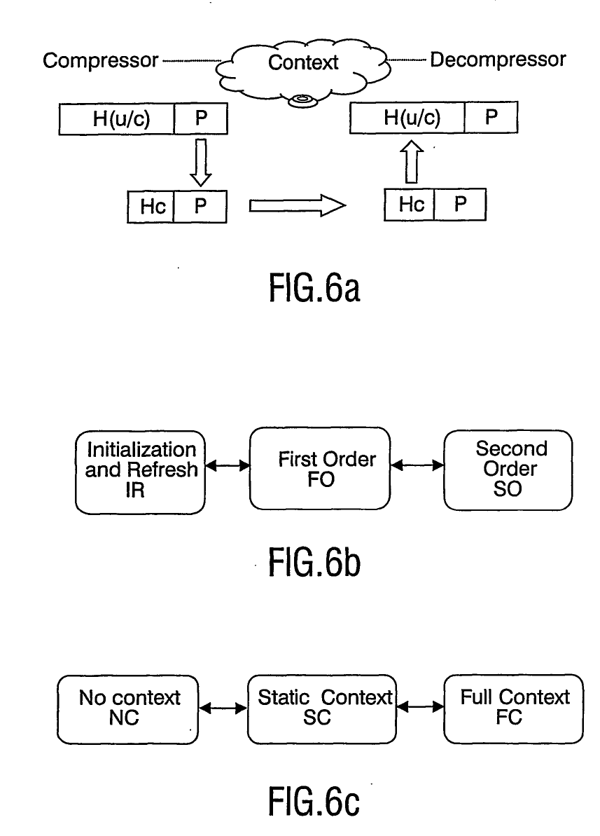

FIG. 6a is a schematic diagram of a header compression and decompression chain;

FIG. 6b is a block diagram of compressor states; and

FIG. 6c is a block diagram of decompressor states.

The present invention will now be described with reference to certain embodiments and with reference to the above mentioned drawings. Such description is by way of example only and the invention is not limited thereto. In particular the present invention will be described with reference to radio communications network but the present invention is not limited thereto. The term “wireless” should be interpreted widely to cover any communications system which does not use fix wireline communications for some of its transmissions. Alternative wireless communications systems include optical systems such as those operating with diffuse infra-red. It should also be noted that the term “wireless” also includes so-called cordless systems. General aspects of cordless communications systems are described for instance in the book by W. Tuttlebee, “Cordless Telecommunications Worldwide”, Springer, 1997. Cordless systems are generally local, uncoordinated radio communications networks having a limited range. It will be noted, however, that all the embodiments of the present invention can be used with the Bluetooth™ protocol. A network operated in accordance with the Bluetooth™ may be described as an uncoordinated cellular system.

The features of such a system may include one or more of:
Slow frequency hopping as a spread spectrum technique;
Master and slave units whereby the master unit can set the hopping sequence;
Each device has its own clock and its own address;
The hopping sequence of a master unit can be determined from its address;
A set of slave units communicating with one master all have the same hopping frequency (of the master) and form a piconet;
Piconets can be linked through common slave units to form a scatternet;
Time Division Multiplex Transmissions (TDMA) between slave and master units;
Time Division Duplex (TDD) transmissions between slaves and masters units;
Transmissions between slave and master units may be either synchronous or asynchronous;
Master units determine when slave units can transmit;
Slave units may only reply when addressed by a master unit;
The clocks are free-running;
Uncoordinated networks, especially those operating in the 2.4 GHz license-free ISM band;
A software stack to enable applications to find other Bluetooth™ devices in the area;
Other devices are found by a discovery/inquiry procedure; and
Hard or soft handovers.
   With regard to frequency hopping, “slow frequency hopping” refers to the hopping frequency being slower than the modulation rate, “fast frequency hopping” referring to a hopping rate faster than the modulation rate. The present invention is not necessarily limited to either slow or fast hopping.

In addition, in the following reference will be made to “mobile terminals” however the present invention is not limited to all user terminals being mobile. Fixed terminals, e.g. a desk top computer, may be used equally well with the present invention. Reference will also be made to “packets” but the present invention is not limited to packet switched systems. The term “packet based” refers to any system which uses packets of information for transmission purposes whether the system is packet or circuit switched or any other type.

In a corporate network 10 depicted schematically in FIG. 2, a user terminal, for example a mobile terminal MT in the form of a third generation (3G) mobile telephone, has an embedded IP stack and is capable of operation as a cordless phone handset. Such operation is achieved by establishing VoIP connections inside the corporate network 10, which may be embodied as an intranet The mobile handset MT uses one of a set of access points AP_{1 . . . n} in the intranet to establish a Voice-over-IP (VoIP) connection in order to make or receive calls. The calls may be made either through a router and dedicated gateway (PABX/GW) to a telephone network or within the intranet, e.g. with one or more other handsets MT (no further terminals shown) by using the H.263 or Session Initiation Protocol (SIP) signaling standard.

Instead of using an SCO link between the mobile phone MT and the access point AP_{1 . . . n}, a conventional data link is created and VoIP traffic is exchanged between the mobile phone and the PABX gateway through the access point. Using a conventional technique, the mobile terminal MT must implement a full VoIP terminal and the associated protocol stack is illustrated with particular reference to FIG. 3.

VoIP over Bluetooth Protocol Stack:

In the VoIP solution, voice is encoded at 5.3 kbps (with silence suppression) according to the G.723.1 standard (e.g. used in GSM) and coded samples are first packetized into a payload of 20 bytes, then time-stamped according to the real-time protocol (TP) and finally transmitted into a UDP/IP datagram. With such a scheme, an IP datagram that carries voice samples is generated each 30 ms.

Since a VoIP packet has a 40 bytes header and a 20 bytes payload, a robust header compression (ROHC) algorithm must be applied to save bandwidth and reduce the header length to between four and ten bytes (depending on channel conditions), by exploiting the redundancy between consecutive header fields. The header compression algorithm must be robust against transmission errors that cause packet losses. An overview of header compression and decompression is presented with reference in particular to FIGS. 6a to 6c.

As reference has been made herein to header compression techniques, and in particular to Robust Header Compression (ROHC), it is considered useful to provide a summary of some aspects of these techniques but, for a more detailed understanding, the reader is referred to the July 2001 article:

“Robust Header Compression (ROHC): Framework and four profiles: RTP, UDP, ESP and uncompressed” by C. Borman et al., which can be found via the “Internet Engineering Task Force” (IETF) website under the reference “RFC3095” and is accessible through the URL: http://www.ietforg/rfc/rfc3095.txt

In general, header compression mechanisms reduce header overhead by taking advantage of the fact that it is not necessary to send static header fields in every packet because they do not change during a session, such static header fields comprising for example IP addresses and UDP ports. Furthermore, it is possible to efficiently handle the fields that change during the sessions (e.g. RTP timestamp, RTP sequence number and IP identification), so that header overhead can be reduced even more. In some cases, these so-called “changing fields” can be predicted from previous packets using a simple linear extrapolation. Other header fields (e.g. IP header length and UDP length) can be inferred from data-link level and it is not necessary to transmit them, these fields being referred to as “inferred fields”.

A header compression scheme was proposed by S. Casner and V. Jacobson in their February 1999 article “Compressing IP/UDP/RTP Headers for Low-Speed Serial Links” (Internet RFC 2508). This arrangement compresses RTPIUDP/IP headers, but was not designed to handle the error rates and round-trip delay encountered on typical wireless links.

Techniques have been proposed for adapting header compression to the wireless environment, such as for example “ACE” (Adaptive header Compression) and “ROCCO” (Robust Checksum-based header Compression). “ACE” introduces a field encoding scheme “changing fields” (“Window-based Least Significant BIT” W-LSB) that uses a number of reference values contained in a variable sliding window (VSW), which are communicated to the decompressor. ROCCO uses a CRC to verify correct reconstruction in the decompressor and to avoid error propagation.

The IETF ROHC Working Group is currently studying new compression schemes that work well over links with high error rates and long round-trip times. The schemes must perform well for cellular links built using technologies such as WCDMA, EDGE, and CDMA-2000. However, the schemes should also be applicable to other future link technologies with high loss and long roundtrip times, such that compression may be achieved over unidirectional links. The IETF ROHC uses and combines all techniques studied by ACE and ROCCO and details may be found through the IETF ROHC Working Group URL at: http://www.ietf.org/html.charters/rohc-charter.html.

ROHC provides an extensible framework for robust header compression that is applicable to RTP/UDP/IP streams over wireless channels. Support for compression of TCP/IP headers and other kinds of protocols (e.g. Mobile IPv6) is also being added and to date four profiles have been defined by the ROHC RFC:

| | |
|---|---|
| 0 | Uncompressed IP packets |
| 1 | RTP/UDP/IP |
| 2 | UDP/IP |
| 3 | ESP/IP |

Reference will be made in particular to profile 1.

The ROHC compressor and decompressor need to maintain context information so that dynamic fields of the real-time flow are correctly processed and headers reconstructed accordingly, while static header fields, i.e. those that remain unchanged within a given context, are not transmitted at all. A diagram of a compression and decompression chain can be seen with particular reference to FIG. 6a.

For an RTP/UDP/IP flow, the dynamic fields are listed below:

| | |
|---|---|
| IP Identification (16 bits) | IP-ID |
| UDP checksum (16 bits) | |
| RTP marker (1 bit) | M-bit |
| RTP Sequence Number (16 bits) | SN |
| RTP Timestamp (32 bits) | TS |

All other header fields are either static or inferred.

Initially the compressor is in the “Initialization and Refresh” (IR) state, where the headers are sent non-compressed so that the decompressor can create a context for the IP flow. In the “First Order” (FO) state, the compressor only sends updates of the static fields to the decompressor to compensate for irregularities in the stream that may corrupt the context. Therefore, in this state, the compressor sends only context updates. In the “Second Order” (SO) state, the compressor sends compressed headers since it is confident that the decompressor has already received a valid context. Please see in particular FIG. 6b.

The decompressor starts in a “No-Context” (NC) state. Upon successful decompression of a header, it goes to “Full Context” (FC) state, which is the normal operating state. Only after repeatedly decompressing headers does it go to a “Static Context” (SC) state, in which it waits for context update packets sent by the compressor in the FO state. If a valid context cannot be recovered, the decompressor returns to the NC state. Please see in particular FIG. 6c.

Transitions between states are governed by operating modes, of which ROHC defines three: “unidirectional” (U-mode), “bi-directional optimistic” (0-mode) and “bi-directional reliable” (R-mode). In U-mode, a feedback channel from the decompressor to the compressor does not exist (or cannot be used) so that transitions between compressor states are based on only periodic timeouts and irregularities in the incoming packet headers. In this case, periodic refreshes of the context are needed. In the 0-mode, a feedback channel is used for error recovery requests and (optionally) acknowledgements of context updates. The rational behind this operating mode is to minimize the use of the feedback channel. Finally, the R-mode makes intensive use of the feedback channel in order to maximize robustness against loss propagation and damage propagation.

W-LSB Encoding:

Given a header field value to compress “v”, the W-LSB algorithm transmits only its least significant bits, provided a suitable reference value (v_ref) is maintained both at the compressor and at the decompressor. In order to avoid mismatches between “v_ref” values, a suitable robust algorithm is defined which selects “v_ref” within a variable sliding window VSW. The number of least significant bits “k” to transmit for the value “v” to be compressed is selected as explained below.

Let:
f(v_{—}ref,k)=[v_{—}ref−p,v_{—}ref+(2^{k-1})−p] (1)
be an interval in which v is expected to vary. The offset parameter p can be chosen according to the behavior of the specific field to compress.

Now, at the compressor the value k could be chosen in such a way that:
k=g(v_{—}ref,v)=min k:v εf(v_{—}ref,k) (2)
So k would be the minimum value such that v falls in the interval f(v_ref, k).

However, this scheme might not be robust against errors because the compressor has no knowledge that the decompressor is using the same reference value (which could actually be different because of transmission errors). Instead, a variable sliding window is introduced:
VSW={v_{1-w},v₁} (3)
which contains the last w values that have been transmitted. Whenever a new value enters the compressor, it is appended to VSW. When the compressor is sufficiently confident that some of the older values in VSW have been correctly received, those values are removed from vsW.

We define:
vₘᵢₙ=min(VSW),vₘₐₓ=max(VSW) (4)
as the minimum and maximum values in VSW.

In the W-LSB coding scheme, the selection of k is made according to the following formula:
k=max(g(v,vₘᵢₙ),g(v,vₘₐₓ)) (5)
where g( ) has been defined in (2).

In this way, a higher number of bits is used to encode the field due to the uncertainty that the decompressor has a good reference interval for decoding the transmitted m bits. In fact, the decoding technique at the decompressor is based on the following algorithm.

Let:
I_{d}=f(v_{—}ref_{—}d,m) (6)
be defined as the interpretation interval given the last correctly decompressed value v_ref_d and the number of bits received m. The decompressed field is simply derived by picking the value in the above interpretation interval whose m least significant bits match the received m bits.

The size w of the variable sliding window depends on the confidence that the compressor has on the decompressor state, which in turn depends on the selected ROHC mode. For U and 0 modes, w is implementation dependent. The syntax of the ROHC compressed packets (defined later) sets the allowed dimensions of w. In fact, since each packet type has a certain number of bits reserved for a coded header field, this automatically defines the window dimension. For example, the RTP-SN is reserved four bits in the UO-0 packet, which means the window length is set to 16 (i.e. up to 15 packets can be lost). In R-mode explicit feedback from the decompressor can be used to minimize the sliding window dimension and therefore maximizing the compression ratio.

The W-LSB algorithm may be further explained through a simple example. Let us assume that the compressor has transmitted the values 151, 152, 153, 154 and 155 and that the last three ones have not been received because of transmission errors on the wireless link. Then, at the compressor:
VSW=[151,152,153,154,155], vₘᵢₙ=151 and vₘₐₓ=155.
Now the value 156 enters the compressor. The number of least significant bits k to transmit is given by (5), which yields k=max (3,1)=3. So the last three LSBs of the value 156=‘10011100’ are transmitted (‘100’).

At the decompressor, since the values 153, 154 and 155 have been lost, the last good reference value is 152. According to (6), the decompressor has an interpretation interval I_{d}=[152, 159], which is expanded below.

| Dec | Bin |
|---|---|
| 152 | 10011000 |
| 153 | 10011001 |
| 154 | 10011010 |
| 155 | 10011011 |
| 156 | 10011100 <<< |
| 157 | 10011101 |
| 158 | 10011110 |
| 159 | 10011111 |

It can be noticed that within this interval the only value whose three LSBs. match the pattern ‘100’ is 156. The correctness of the decompression can be checked by applying a small CRC to the original header (3 to 8 bits depending on mode) in order to avoid that an undetected transmission error leads to a wrong decompressed value, which, in turn, would be used later as a reference value, leading to damage propagation. Failure of the CRC to detect a damaged value is also compensated for in the ROHC framework.

Other Encoding Schemes:

The W-LSB coding algorithm is not the only one that can be used in the ROHC framework. Other schemes exist that take advantage of specific characteristics of some header fields such as, for example, the RTP timestamp, which usually increases in regular steps over time (multiple of a TS_STRIDE value). This characteristic is exploited by “scaled RTP timestamp” encoding.

RTP timestamp can also be approximated with a linear function of the time of day for traffic generated at constant rate, fixed sampling frequency and when packet generation is locked to the sampling frequency. In this case “timer-based compression of RTP timestamp” applies.

The IP identification field (IP-ID) is encoded by considering only offsets between the IP-ID and the RTP sequence number (the latter increases by one for each new packet) and applying W-LSB encoding to such offsets.

After header compression using ROHC, the packet is encapsulated using the Bluetooth Network Emulation Protocol (BNEP), as will now be explained. The Personal Area Network (PAN) working group standardizes IP over Bluetooth and, for this purpose, has developed a new protocol named the “Bluetooth Network Encapsulation Protocol” (BNEP). This protocol defines a packet format for Bluetooth network encapsulation used to transport common networking protocols over the Bluetooth media. The BNEP provides an Ethernet emulation for Bluetooth and adds another header, whose length ranges from 3 to 15 bytes. By way of BNEP, IP datagrams are encapsulated into Ethernet frames and sent to the underlying L2CAP layer. By introducing the Ethernet emulation layer, it is possible to implement broadcasting, multicasting and Layer-2 bridging functions, e.g. in network access points or in Bluetooth ad-hoc networks. Full details of the BNEP can be obtained through the Bluetooth SIG and their website referred to above. Finally, the BNEP packet is encapsulated into an L2CAP frame, which is segmented into multiple baseband packets. With the RTPJUDP/IP header compression scheme, each VoIP packet needs two DM1 packets to be transmitted. In special circumstances and with variations of the protocol stack shown in FIG. 3, is possible to transmit a VoIP frame in a single baseband slot.

Delay Sensitiveness of Voice Real-Time Traffic:

Since VoIP traffic is delay-sensitive, each packet must arrive at the receiver within a certain amount of time. If a VoIP frame is delayed beyond a certain time limit because of baseband packet retransmissions caused by channel errors, it must be discarded. Therefore in bad channel conditions, a delay-sensitive L2CAP frame that has not been fully transmitted within a settable threshold must be automatically flushed, to save bandwidth and power. In the Bluetooth, standard it is possible to negotiate an automatic flush timeout on each L2CAP logical channel between two peer entities. This negotiation is performed during the L2CAP channel configuration process, as can be seen with reference to the flow chart of FIG. 5.

According to the present invention, by using Voice-over-IP codecs and properly managing the low-power modes available in Bluetooth, the power consumption of the mobile voice termiinal MT is significantly reduced in comparison with conventional techniques. The present invention achieves this by providing a channel state dependent algorithm to select the duration of the so-called “SNIFF” low-power mode according to an estimation of the channel bit error rate and the retransmission timeout.

The amount of time to transmit a VoIP packet over a Bluetooth ACL link depends on various factors. First of all, wireless channel conditions: the higher the bit error rate, the higher the number of retransmissions for each baseband packet to transmit. Secondly, the length of the packet: in case of frame losses (due to the L2CAP timeout) the compression ratio for the packet header decreases, leading to longer frames to transmit, according to ROHC algorithms.

In FIG. 4, the time necessary to transmit a VoIP frame is shown in terms of Bluetooth slots in the ideal case of no packet retransmissions. It can be seen that the active period necessary to exchange two voice packets between the master (e.g. access point AP) and the slave (e.g. the mobile terminal MT) is rather limited. In fact, packet 1 carries the first DM1 packet from the master to the slave, packet 2 acknowledges packet 1 and carries the fist DM1 packet from the slave to the master. Packet 3 acknowledges packet 2 and carries the second DM1 packet from the master to the slave. Finally, packet 5 only carries the acknowledgement for packet 4.

According to the present invention, the Bluetooth SNIFF mode is used such that the transceiver of the mobile phone goes to sleep between two consecutive VoIP packets which are to be transmitted, given the knowledge of packet generation rate and channel conditions. The active SNIFF period is shown with the thick line 12 in FIG. 4.

In the ideal case of no packet retransmissions, the ratio between the transceiver active period and the period of voice packet generation is:
ηₒₚₜ=t_{A}/t_{G}= 5/48=10.4%,
which represents a gain of Gₒₚₜ=η_{ACL}/η_{SCO}=˜3.2, compared to the use of SCO links in terms of power consumption (it is assumed here, that the power consumed to transmit and to receive a baseband packet is the same). The gain decreases as the channel bit error rate increases, up to a limit t_{A}*, where, in theory, the system consumes the same power as the system that uses the SCO link. In practice, however, since the G.723.1 voice codec uses silence suppression, the VoIP system is still more power efficient than the simpler one with SCO links.

Adaptivity of the SNIFF Mode:

According to an aspect of the present invention, it is proposed to adapt the 25 active period used in the SNIFF mode according to the estimated wireless channel conditions.

The SNIFF mode is negotiated between the master and the slave for an existing baseband connection. Once the active period has been agreed, the master is responsible for polling the slave during the indicated active period (see later section). Packet retransmissions are allowed to extend beyond the sniff active period limit, if needed. With an L2CAP timeout of 12.5 ms (20 baseband slots), simulation results of tests carried out by the applicants show that less than 10% of VoIP frames are discarded up to a bit error rate (PER) of 2.7×10⁻², using DM1 packets.

Therefore it is proposed to set the SNIFF active period (measured in number of baseband slots) as follows:

$${t}_{A , SNIFF} = \{ \begin{matrix}8 , & ber < {B}_{G} \\ 14 , & {B}_{G} < ber < {B}_{B} \\ 20 , & ber > {B}_{B}\end{matrix} \qquad ( 1 )$$

This simple 3-level quantization scheme is based on bit error rate measurements and two thresholds, B_{G} (good channel conditions) and B_{B} (bad channel conditions). The idea is to allow for more baseband retransmissions when the channel bit error rate increases (for example because the mobile terminal has moved away from the access point).

The L2CAP automatic flush timeout associated with the logical channel used to carry the VoIP connection, must be adapted to the SNIFF active mode according to a simple relationship such as:
L2CAP_{flushTO}=t_{A,SNIFF}−2 (2)
The bit error rate indicated in (1) cannot be measured directly in a BT system, but it can be inferred from the number of L2CAP timeout events generated, from the rate of packet retransmissions of from a Received Signal Strength (RSSI) measurement.

A process in the mobile terminal should periodically check the estimated channel conditions and activate a renegotiation of the SNIFF active period and L2CAP flush timeout when necessary.

Implementation Issues:

In this section, some details are given on the relevant Bluetooth commands and constraints that are used to apply the power saving technique that forms part of this application.

Bluetooth SNIFF Mode Parameters:

In the sniff mode, a slave (the mobile termi) starts listening at the sniff slots for a number of N_{sniff attempt} slots until a packet with its AM_ADDR is received. After that, it continues listening for N_{sniff timeout} slots or until received packets match with its own AM_ADDR. Finally, the slave returns to sleep until the next sniff slot event. For the VoIP example detailed above, the following parameters must be used:
N_{sniff attempts}=3
N_{sniff timeout}={8, 14, 20}.
Having set N_{sniff attempt}=3, the master can delay the transmission of a VoIP packet to the slave because of other activities it is performing and still the slave will be able to receive the frame. N_{sniff timeout} is the parameter that is adapted to the channel conditions and determines the amount of time the device remains active on the Bluetooth (BT) channel.

The sniff mode is entered by means of the HCI_Sniff_Mode command, whose parameters are:
Connection_Handle,
Sniff_Max_Interval,
Sniff_Mn_Interval,
Sniff_Attempt,
Sniff_Timeout

The Sniff_Max_Interval and the Sniff_Min_Interval should be the same and match the rate of generation of VoEP packets.

It must be noticed that the SNIFF mode is applied to the baseband link, i.e. to all the L2CAP logical channels that use the link. So, if other traffic sources use the same BT link, the sniff active period should be increased accordingly and a proper scheduling policy (above the HCI layer) should guarantee that L2CAP frames carrying VoIP frames have a higher priority over other traffic sources.

Considerations related to the L2CAP MTU should be taken into account as discussed in another section.

Lower Layers:

Since a slave in the SNIFF mode continues listening at the channel until packets arrive that match its own AM_ADDR, the whole power saving technique could be compromised. Therefore it is recommended that the HCI_Write_Automatic_Flush_Timeout command be used in the master AP and in the slave MT. This guarantees that the master AP aborts packet retransmissions that extend beyond the sniff active period, which would force the slave MT to continue listening to the channel, thereby wasting power unnecessarily. In the slave, this command ensures that a baseband packet that has not been successfully sent to the slave during one sniff active period is flushed in the baseband, to make room for the first packet of the next L2CAP frame. The parameter of the CI_Write_Automatic_Flush_Timeout command should match the SNIFF active period. Each time a baseband packet is flushed, the Failed Contact Counter is incremented by one.

Referring now for the moment in particular to FIG. 5, a flow chart is provided of an embodiment of the invention. Once the VolP application is started, a management entity in the mobile terminal MT configures the channel link characteristics and sets parameters for L2CAP timeout. After that, the sniff period is negotiated with the peer device and a baseband automatic flush timeout is set which matches the L2CAP timeout. Monitoring of the channel conditions is a separate task, which runs independently of the rest of the process. The mechanism adapts to measured wireless channel conditions, such measurements being based on received signal strength indicators (RSSI), baseband packet retransmission rate, L2CAP timeout rate or a combination of these. When channel conditions change noticeably, a re-negotiation of L2CAP and baseband flush timeouts is started. In order to minimize interference with the voice application, this can be done for example during a pause in the conversation. Once sniff and timeout parameters have been matched to the changed channel conditions, the system returns to the normal state where packetized voice samples are transmitted.

The presented technique achieves significant power savings in the Bluetooth link at the cost of some increased mobile terminal complexity. Furthermore, the method presented in this invention disclosure can be integrated in wireless network infrastructures that integrate data and voice services.

While the present invention has been particularly shown and described with respect to a preferred embodiment, it will be understood by those skilled in the art that changes in form and detail may be made without departing from the scope and spirit of the invention.

### GLOSSARY OF ABBREVIATIONS

| | |
|---|---|
| ACL | Asynchronous Connection Less |
| AM_ADDR | Bluetooth Active Member Address |
| AP | Access Point |
| BER | Bit Error Rate |
| BNEP | Bluetooth Network Encapsulation Protocol |
| BT | Bluetooth |
| HC | Header Compression |
| IP | Internet Protocol |
| L2CAP | Logical Link Control and Adaptation Layer |
| LAN | Local Area Network |
| LM | Link Manager |
| MAC | Medium Access Control |
| PAN | Personal Area Network |
| PCM | Pulse Code Modulation |
| ROHC | Robust Header Compression |
| RSSI | Received Signal Strength Indication |
| RTP | Real Time Protocol |
| SCO | Synchronous Connection Oriented |
| TO | Timeout |
| UDP | User Datagram Protocol |
| VoIP | Voice over IP |

1. A method for packet-based wireless transmission between a first unit and a second unit, the method including a said unit:
a) generating packets suitable for transmission between said units;
b) transmitting said packets in succession during active periods on a wireless channel, successive said active periods being spaced apart by a number of timeslots of predetermined duration;
c) implementing a low power mode in timeslots between said active periods; and
d) setting the duration of operation in at least one of said active period and said low power mode in dependence on the status of said channel.

2. A method according to claim 1, including determining said status at least in part according to an estimation of an error rate, preferably a channel bit error rate (BER), or a characteristic related to or derived from an error rate.

3. A method according to claim 2, including deriving said error rate from a number of timeout events, from a rate of packet retransmission or from a received signal strength (RSSI) measurement.

4. A method according to claim 1, including applying a timeout to the transmission of a said packet and setting at least one of said active period and said low power mode at least in part in dependence on the duration of said timeout.

5. A method according to claim 4, including setting the duration of said timeout at least in part in dependence on the length of time taken to transmit a said packet.

6. A method according to claim 1, including setting at least one of said active period and said low power mode at least in part in dependence on the rate of generation of said packets.

7. A method according to claim 1, including determining said status from an estimate of wireless channel conditions between said units.

8. A method according to claim 1, including configuring a said unit as a master unit and the other said unit as a slave unit, and negotiating for an existing baseband connection therebetween the implementation of at least said active period.

9. A method according to claim 8, including periodically checking the status of said channel conditions and renegotiating the duration of said active period and a flush timeout under predetermined circumstances ensuing from a said status check.

10. A method according to claim 8 or claim 9, including making said master unit responsible for polling said slave unit during agreed said active periods.

11. A method according to claim 8, including configuring said slave unit to listen for an attempt at polling during a predetermined number of said timeslots during a said active period and, in the event of receiving a said packet bearing its address, to continue listening for a predetermined listening timeout.

12. A method according to claim 11, including setting the amount of time said slave unit spends active on said channel on dependence on said listening timeout and varying said listening timeout in dependence on channel conditions.

13. A method according to claim 1, including allowing packet transmissions to extend beyond the duration of a said active period under predetermined circumstances.

14. A method according to claim 1, including setting an allowable number of packet retransmissions and increasing said number in response to an increase in channel bit error rate above a level at which a said number was set.

15. A method according to claim 1, including varying a flushing timeout associated with a logical channel used to carry said packets, said variation being dependent on the number of timeslots in said active period.

16. A method according to claim 1, including generating said packets by:
a) converting a real-time bit stream into one or more payloads of predetermined maximum length and applying one or more predefined headers to the or each said payload so as to generate said packets in accordance with a predefined communications protocol;
b) applying a predefined header compression technique to the or each said encapsulated packet and encapsulating the or each said packet within a frame of an encapsulation protocol adapted for transporting the or each said packet across a wireless connection between said units.

17. A method according to claim 1, including generating the or each said payload from a said real time bit stream comprising Internet Protocol (IP) traffic, such as Voice-over-Internet-Protocol (VoIP), audio or visual streams.

18. A method according to claim 1, including operating said units in accordance with the Bluetooth protocol and said low power mode preferably comprising a Bluetooth SNIFF mode.

19. A software product for executing packet-based wireless transmission between a first unit and a second unit, the product including code for:
a) generating packets suitable for transmission between said units;
b) transmitting said packets in succession during active periods on a wireless channel, successive said active periods being spaced apart by a number of timeslots of predetermined duration;
c) implementing a low power mode in timeslots between said active periods; and
d) setting the duration of operation in at least one of said active period and said low power mode in dependence on the status of said channel.

20. A packet based wireless communications arrangement comprising a first unit adapted to communicate information to a second unit substantially in real-time, said first unit being adapted to:
a) generate packets suitable for transmission between said units;
b) transmit said packets in succession during active periods on a wireless channel, successive said active periods being spaced apart by a number of timeslots of predetermined duration;
c) implement a low power mode in timeslots between said active periods; and
d) set the duration of operation in at least one of said active period and said low power mode in dependence on the status of said channel.

21. A wireless communications arrangement according to claim 20, said units being operable in accordance with the Bluetooth protocol and said low power mode preferably comprising a Bluetooth SNIFF mode.

22. A wireless communications unit adapted to operate in accordance with the method of claim 1 and preferably configured at least temporarily as at least one of a master unit and a slave unit of Bluetooth communications network.
